(19) United States
(12) Patent Application Publication
(10) Pub. No.: US 2002/0119245 A1
(43) Pub. Date: Aug. 29, 2002

(54) Method for etching electronic components containing tantalum

(76) Inventor: Steven Verhaverbeke, San Francisco, CA (US)

Correspondence Address: Woodcock Washburn LLP, 46th Floor, One Liberty Place, Philadelphia, PA, 19103, US

(21) Appl. No.: 10/074,516

(22) Filed: Feb. 13, 2002

Related U.S. Application Data
(60) Provisional application No. 60/270,815, filed on Feb. 23, 2001.

(51) Int. Cl. B05D 5/12; B05D 3/10; B05D 1/18

(52) U.S. Cl. 427/58; 427/126.3; 427/343; 427/430.1

(57) ABSTRACT

The present invention provides methods of wet processing electronic components having surfaces containing tantalum. In the methods of the present invention, tantalum-containing electronic components are contacted with a tantalum processing fluid comprising a tantalum oxidizing solution containing an oxidizing agent and a fluorine ion producing agent.

### CROSS REFERENCE TO RELATED APPLICATIONS

The present application claims the benefit of priority under 35 U.S.C. § 119(e) from provisional U.S. Application Serial No. 60/270,815, filed on Feb. 23, 2001, which is incorporated herein by reference in its entirety.

### FIELD OF THE INVENTION

This invention relates to methods for wet processing electronic components having surfaces containing tantalum or tantalum nitride. The methods of the present invention are particularly useful for cleaning such tantalum-containing electronic components.

### BACKGROUND OF THE INVENTION

Wet processing of electronic components, such as semiconductor wafers, flat panels, and other electronic component precursors, is used extensively during the manufacture of integrated circuits. Preferably, wet processing is carried out to prepare the electronic component for processing steps such as diffusion, ion implantation, epitaxial growth, chemical vapor deposition, hemispherical silicon grain growth, or combinations thereof. During wet processing, the electronic components are contacted with a series of processing solutions. The processing solutions may be used, for example, to etch, remove photoresist, clean, or rinse the electronic components. See, e.g., U.S. Pat. Nos. 4,577,650; 4,740,249; 4,738,272; 4,856,544; 4,633,893; 4,778,532; 4,917,123; and EP 0 233 184, assigned to a common assignee, as well as Burkman et al., Wet Chemical Processes-Aqueous Cleaning Processes, pages 111-151 in Handbook of Semiconductor Wafer Cleaning Technology (edited by Werner Kern, Published by Noyes Publication Parkridge, N.J. 1993), the disclosures of which are herein incorporated by reference in their entirety.

There are various types of systems available for wet processing. For example, the electronic components may be processed in a single vessel system closed to the environment (such as a Full-Flow™ system supplied by Mattson), a single vessel system open to the environment, or a multiple open bath system (e.g., wet bench) having a plurality of baths open to the atmosphere.

Following processing, the electronic components are typically dried. Drying of the semiconductor substrates can be done using various methods, with the goal being to ensure that there is no contamination created during the drying process. Methods of drying include evaporation, centrifugal force in a spin-rinser-dryer, steam or chemical drying of wafers, including the method and apparatus disclosed in, for example, U.S. Pat. Nos. 4,778,532; 4,911,761; and 4,984,597.

With respect to wet process methods used for cleaning electronic components, much effort has been devoted to finding suitable cleaning processes for electronic components made predominantly of silicon with minor amounts of other components such as aluminum, silicon oxide, silicon nitride, titanium or titanium-containing compounds (e.g., titanium nitride or titanium silicide), tungsten or tungsten-containing compounds (e.g., tungsten silicide), cobalt silicide, or combinations thereof.

Diffusion barriers are used in semiconductor devices to prevent metal in a metal layer from diffusing into an underlying dielectric layer. For example, a barrier layer is typically formed between an SiO₂ or Si₃N₄ dielectric layer and an Al or Cu metal layer. Traditionally, diffusion barriers such as Ti or TiN have been used in semiconductor processing when the metal is aluminum. However, with the use of copper in electronic components for lower resistivity applications, traditional diffusion barriers have been found to be ineffective. Tantalum or tantalum nitride has been found to be an excellent alternative diffusion barrier for use in semiconductor processing. In particular, Ta and TaN are effective diffusion barriers in the presence of copper, even at temperatures as high as 200° C.

However, during device manufacturing it is often important to be able to remove or etch portions of the Ta or TaN layer. In some applications, such as reclaiming wafers, the entire surface will be covered with Ta or TaN and this barrier layer must be removed completely. In other applications, a patterned etch may be necessary, in which the Ta or TaN is removed only from specific areas of the water surface.

Current methods of removing Ta and TaN include sputter etching and Chemical Mechanical Polishing (CMP). Sputter etching is useful for a patterned etch because very specific areas can be removed in an anisotropic manner. However, sputtering is fundamentally a dirty process because material removed by sputtering can redeposit on exposed surfaces. The redeposited material is difficult to remove, thereby limiting the processing yield. CMP is effective when an entire layer of Ta or TaN needs to be removed, however, CMP is an expensive process and the substrates must be cleaned after the CMP step is completed. Tantalum is known to be relatively insoluble in aqueous solutions and, therefore, wet etching has not been developed to date.

In light of the foregoing, a wet etching process to remove Ta or TaN would be highly beneficial. The wet etching process should allow greater control of the etching process as compared to the known methods. Further, the wet etching process should eliminate an extra processing step because there is no residue or redeposited material to remove after the wet etch. The wet etching process should be able to be completed in a single step, thereby reducing the process time and improving throughput. It is desirable for the wet processing method to be able to etch 200-300 Å in about 10 minutes. Additionally, the wet etching process should be able to provide an anisotropic etch using techniques such as controlled etching and/or mask design. Also, the wet etching process should be relatively inexpensive as compared to the known methods, such as CMP.

### SUMMARY OF THE INVENTION

The present invention provides methods of wet processing electronic components having tantalum or tantalum nitride containing surfaces. The methods of the present invention include contacting the surfaces of the electronic components with a tantalum oxidizing solution and a fluorine ion producing agent maintained at an aqueous pH of 5 or lower. The surfaces of the electronic components are contacted simultaneously with the tantalum oxidizing solution and the fluorine ion producing agent for a time sufficient to remove the desired amount of tantalum and/or tantalum nitride from the surfaces of the electronic components. In the methods of the present invention, the oxidation and etching of the oxidized tantalum by the fluorine ion solution occur concurrently, so the entire process can be completed in a single step, thereby reducing process time and improving throughput. Further, the methods described are capable of etching 200-300 Å in about 10 minutes.

In a preferred embodiment, the present invention provides a method of wet processing electronic components having surfaces containing tantalum that includes placing one or more electronic components in a single vessel; filling the vessel with a tantalum oxidizing solution comprising an oxidizing agent and a fluorine ion producing agent having a pH of 5. The surfaces of the electronic components are contacted with the tantalum oxidizing solution and the fluorine ion producing agent for a time sufficient to remove tantalum and/or tantalum nitride from the surfaces of the electronic components. The tantalum oxidizing solutions and fluorine ion producing agent can then be removed from the vessel.

### DETAILED DESCRIPTION OF THE INVENTION

The present invention provides methods for wet processing electronic components having surfaces containing tantalum. The methods of the present invention are particularly useful for etching such electronic components to remove part or all of a layer containing tantalum and/or tantalum nitride.

The methods of the present invention are useful in any wet processing procedure where it is desired to etch electronic components having tantalum-containing surfaces. By “wet processing” it is meant that the electronic components are contacted with one or more process liquids to process the electronic components in a desired manner. For example, it may be desired to treat the electronic components to clean, etch, or remove photoresist from the surfaces of the electronic components. It may also be desired to rinse the electronic components between such treatment steps. Wet processing may also include steps where the electronic components are contacted with other fluids, such as a gas, a vapor, or a liquid mixed with a vapor or gas, or combinations thereof. As used herein, the term “fluid” includes liquids, gases, liquids in their vapor phases, or combinations thereof. Typically, such wet processing is carried out to prepare the electronic components for processing steps such as dielectric chemical vapor deposition, plasma etch, reactive ion etching, or combinations thereof.

There are various types of process fluids used during wet processing. Generally, the most common types of process fluids used during wet processing are “chemical treatment” fluids or liquids and “rinsing” liquids or fluids. As used herein a “chemical treatment liquid” or “chemical treatment fluid” is any liquid or fluid that reacts in some manner with the surfaces of the electronic components to alter the surface composition of the electronic component. For example, the chemical treatment liquid or fluid may have activity in removing contamination adhered or chemically bound to the surfaces of the electronic components, such as particulate, metallic, photoresist, or organic materials. Additionally, the chemical treatment fluid may have activity in etching the surfaces of the electronic component or activity in growing an -oxide layer on the surface of the electronic component. As used herein, “rinsing liquid” or “rinsing fluid” refers to de-ionized (DI) water or some other liquid or fluid that removes from the electronic components and/or vessel residual chemical treatment fluids, reaction by-products, and/or particles or other contaminants freed or loosened by the chemical treatment step. The rinsing liquids or fluids may also be used to prevent redeposition of loosened particles or contaminants onto the electronic components or vessel. Examples of chemical treatment fluids and rinsing fluids useful in the methods of the present invention are described in more detail hereinafter.

As used herein,“chemical treatment step” or “wet processing step” refers to contacting the electronic components with a chemical treatment fluid or process fluid, respectively.

By “electronic components having tantalum-containing surfaces” it is meant that the electronic components preferably have surfaces that are at least about 0.1 percent covered with tantalum, or a tantalum-containing compound such as tantalum nitride, based on the total surface area of the electronic components. The thickness of tantalum or tantalum-containing compound on the surface is preferably at least about 0.1 microns and more preferably from about 0.5 microns to about 5 microns. Thus, at least one surface of the electronic components are at least partially covered with tantalum or tantalum-containing compound. In the case of partial coverage, the electronic components can be covered with tantalum or tantalum-containing compound in a patterned fashioned. Examples of electronic components that have surfaces containing tantalum include electronic component precursors such as semiconductor wafers, flat panels, and other components used in the manufacture of electronic components (i.e., integrated circuits); hard drive memory disks; and multichip modules.

Although tantalum and tantalum nitride are very insoluble in aqueous solutions, Ta and TaN readily form stable oxides which can readily be etched and are soluble in aqueous solutions. Accordingly, in the wet processing methods of the present invention, electronic components having tantalum-containing surfaces are contacted with a tantalum processing fluid comprising a tantalum oxidizing solution and a solution containing fluorine ions. Although in no way intending to be bound by theory, it is believed that the tantalum oxidizing solution oxidizes the tantalum-containing surfaces to form a thin (e.g., less than about 1.0 nm) layer of a tantalum oxide or combinations of different tantalum oxides. The fluorine ion producing agent is believed to etch this layer of oxide at a controlled rate.

The tantalum oxidizing solution that the electronic components are contacted with is any liquid that is capable of oxidizing the tantalum located on the surfaces of the electronic components. Because tantalum and tantalum nitride are readily oxidizable, even weak oxidizing agents can be used. However, preferred oxidants will oxidize the tantalum or tantalum nitride sufficiently fast so that the oxidation step is not rate limiting. Toward that end, it is preferred that the oxidant reacts sufficiently fast so that the overall etch rate is at least 10-20Å per minute. Suitable tantalum oxidizing solutions include for example solutions containing oxidizing agents such as hydrogen peroxide, ozone, chromic acid, nitric acid, iron cyanide, organic acids, or combinations thereof. Preferably, the oxidizing agent is hydrogen peroxide. These oxidizing agents are preferably dissolved or dispersed in any compatible liquid, for example, water or non-oxidizable organic solvents such as acetic acid, fluorinated hydrocarbons, or combinations thereof. Preferably, the oxidizing agent is dissolved or dispersed in water. It is also possible that the oxidizing agent could be a liquid so that it would not be necessary to dissolve the oxidizing agent in a liquid.

The concentration of the oxidizing agent in the tantalum oxidizing solution will depend on the oxidizing agent chosen. In the case of hydrogen peroxide, the concentration of hydrogen peroxide in the tantalum oxidizing solution is preferably from about 0.1 volume percent to about 10 volume percent, and more preferably from about 0.2 volume percent to about 1.0 volume percent, based on the total volume of the tantalum oxidizing solution.

The electronic components are simultaneously contacted with a fluorine ion producing agent. The fluorine ion producing agent is any liquid containing an agent that provides fluorine ions (i.e.,F⁻) in solution. For example, the fluorine ion solution may contain any of a number of fluorine ion producing compounds such as hydrofluoric acid (HF), buffered hydrofluoric acid (BHF), ammonium fluoride, any other substance which generates fluorine ions in solution, or combinations thereof. The fluorine ion producing compound is preferably dissolved or dispersed in water, but may also be dissolved in an organic solvent such as ethylene glycol, acetic acid, propylene carbonate, methanol, or combinations thereof.

The concentration of the fluorine ion producing agent will depend on the source of fluorine ions chosen. In the case of hydrofluoric acid, the hydrofluoric acid is preferably present in the fluorine ion solution in a volume ratio of solvent:HF of from about 5:1 to about 1000: 1, more preferably from about 100:1 to about 800:1, and most preferably from about 200:1 to about 600:1.

The concentration of fluorine ions in the fluorine ion producing agent can be varied considerably. Different ionic and molecular species are known to be present at different concentrations and these different species may have substantially different etch rates. Accordingly, the etch rate is not expected to be a simple function of the concentration of the fluorine ion producing agent. Therefore, the concentration of the fluorine ion producing agent should be adjusted to provide the desired etch rate under the particular system and conditions employed. For example, when a solution containing hydrogen peroxide and buffered hydrofluoric acid is used, the relative concentrations of the components are preferably between about 5:1:1:1 and about 20:1:1:1 (Deionized water:HF:NH₄0H:H₂O₂).

The tantalum oxidizing solution and the fluorine ion producing agent is preferably maintained at a pH of equal to or less than about 5, more preferably at a pH of equal to or less than about 4, and most preferably at a pH of equal to or less than about 3. The pH may be maintained within this range, for example, through the addition of a buffering agent or acid. Suitable acids include for example, hydrochloric acid, sulfuric acid, iodic acid, bromic acid, phosphoric acid, or combinations thereof. Preferably, the buffering agent or acid is hydrochloric acid because of its volatility (which helps to insure that the buffering agent does not remain on the surface of the processed component after processing) and availability.

The tantalum processing fluid of the present invention may also contain other additives to enhance wet processing. For example, the tantalum processing fluid may also contain surfactants, anti-corrosion agents, or any other conventional additive typically added to wet processing liquids used for cleaning. Preferably, these other additives are present in the tantalum processing fluid in an amount of less than about 5.0 percent by volume and more preferably from about 0.01 percent by volume to about 1.0 percent by volume.

If it is desired to include surfactants in the tantalum processing fluid, the surfactants are preferably present in an amount of less than about 1 percent by volume, and more preferably less than about 0.5 percent by volume, based on the total volume of the tantalum processing fluid. Examples of surfactants that may be used include anionic, nonionic, cationic and amphoteric surfactants disclosed in for example Kirk-Othmer Concise Encyclopedia of Chemical Technology, published by John Wiley & Sons, N.Y., 1985, pages 1142 to 144 and McCutcheon's Detergents and Emulsifiers, 1981 North American Edition, MC Publishing Company, Glen Rock, N.J. 1981, which are incorporated herein by reference in their entireties. Preferred surfactants for use in the present invention are VALTRON® surfactants such as VALTRON® SP2275 and SP2220 supplied by Valtech Corporation of Pughtown, Pa; NCW601A supplied by Wako Company; and citric acid.

If it is desired to include anti-corrosion agents in the tantalum processing fluid, the anti-corrosion agents are preferably present in the tantalum processing fluid in an amount of from about 0.1 weight percent to about 1.0 weight percent based on the total weight of the tantalum processing fluid. Examples of anti-corrosion agents that may be used include for example benzotriazole.

The electronic components are preferably contacted with the tantalum processing fluid for a contact time sufficient to assure that a uniform layer of tantalum oxide forms across the wafer, and so that some tantalum removal occurs due to oxidation of the tantalum and dissolution of the tantalum oxide. By “contact time,” as used herein, it is meant the time an electronic component is exposed to a process liquid. For example, the contact time will include the time an electronic component is exposed to the process liquid during filling a vessel with the process liquid or immersing the electronic component in the process liquid; the time the electronic component is soaked in the process liquid; and the time the electronic component is exposed to the process liquid while the process liquid or electronic component is being removed from the vessel. The actual contact time chosen will depend on such factors as the amount of tantalum or tantalum nitride to be etched, the oxidizing agents present in the tantalum oxidizing solution, the concentration of the oxidizing agent, and the temperature of the tantalum oxidizing solution. Preferably, however, the contact time will be at least 30 seconds.

The temperature of the tantalum processing fluid during contacting is such that etching of the tantalum is sufficiently fast and decomposition of the oxidizing agent in the tantalum oxidizing solution is minimized. The temperature of the tantalum processing fluid is preferably between about 0° C. and about 100° C., more preferably between about 25° C. and 90° C., and even more preferably between about 30° C. and about 70° C.

The contacting of the electronic components with the tantalum processing fluid may be carried out by any known wet processing technique and will depend largely upon the wet processing system chosen. For example, one or more electronic components may be immersed in and withdrawn from a bath containing the tantalum processing fluid. Alternatively, the electronic components may be placed in a vessel and the tantalum processing fluid may be directed through the vessel to fill the vessel with the solution to achieve contacting. Contacting can be carried out under dynamic conditions (e.g., continuously directing the solution through a vessel containing the electronic components), under static conditions (e.g., soaking the electronic components in the solution) or a combination of both (e.g., directing the solution through the vessel for a period of time, and then allowing the electronic components to soak in the solution for another period of time). Suitable wet processing systems for contacting the electronic components are described in more detail hereinafter.

It has been found in the present invention, that it is preferable to maintain the tantalum processing fluid at conditions to promote a controlled etching rate (e.g., less than about 10 nm per minute of tantalum and, more preferably, less than about 1 nm per minute). Factors that affect the tantalum etching rate include the concentration of fluorine ion source in the tantalum processing fluid, the pH of the tantalum processing fluid, the amount of dissolved or suspended oxygen in the tantalum processing fluid, and the temperature of the tantalum processing fluid. For example, the etching rate of tantalum is reduced by decreasing the concentrations of hydrofluoric acid in the tantalum processing fluid. The etching rate is also reduced by increasing the pH and the temperature of the fluid.

The electronic components can also be treated with one or more chemical treatment fluids. The optional chemical treatment fluids useful in the present invention contain one or more chemically reactive agents to achieve the desired surface treatment. Preferably, the concentration of such chemically reactive agents will be greater than 1000 ppm and more preferably greater than 10,000 ppm, based on the weight of the chemical treatment fluid. It is also possible for the chemical treatment fluid to contain 100% of one or more chemically reactive agents. For example, cleaning fluids typically contain one or more corrosive agents such as an acid or base. Suitable acids for cleaning include, for example, sulfuric acid, hydrochloric acid, nitric acid, or aqua regia. Suitable bases include, for example, ammonium hydroxide. The desired concentration of the corrosive agent in the cleaning fluid will depend upon the particular corrosive agent chosen and the desired amount of cleaning. These corrosive agents may also be used with oxidizing agents such as ozone or hydrogen peroxide. In addition to cleaning fluids, it may also be desired to contact the electronic components with solvents such as acetone, isopropanol, N-methyl pyrrolidone, or combinations thereof. Such solvents are chemically reactive agents used, for example, to remove organics or to provide other cleaning benefits.

One skilled in the art will recognize that there are various process fluids that can be used during wet processing. Other examples of process fluids that can be used during wet processing are disclosed in “Chemical Etching” by Werner Kern et al., in Thin Film Processes, edited by John L. Vosser et al., published by Academic Press, N.Y. 1978, pages 401-496, which is incorporated by reference in its entirety.

In addition to optionally contacting the electronic components with chemical treatment fluids, the electronic components may also be contacted with rinsing fluids. As previously described, rinsing fluids are used to remove from the electronic components and/or vessel residual chemical treatment fluids, reaction by-products, and/or particles or other contaminants freed or loosened by a chemical treatment step. The rinsing fluids may also be used to prevent redeposition of loosened particles or contaminants onto the electronic components or vessel.

Any rinsing fluid may be chosen that is effective in achieving the effects described above. In selecting a rinsing fluid, such factors as the nature of the surfaces of the electronic components to be rinsed, the nature of contaminants dissolved in the chemical treatment fluid, and the nature of the chemical treatment fluid to be rinsed should be considered. Also, the proposed rinsing fluid should be compatible (i.e., relatively nonreactive) with the materials of construction in contact with the fluid. Rinsing fluids which may be used include for example water, organic solvents, mixtures of organic solvents, ozonated water, or combinations thereof. Preferred organic solvents include those organic compounds useful as drying solutions disclosed hereinafter, such as C₁ to C₁₀ alcohols, and preferably C₁ to C₆ alcohols. The rinsing fluid is preferably a liquid and, more preferably, deionized water.

Rinsing fluids may also optionally contain low levels of chemically reactive agents to enhance rinsing. For example, the rinsing fluid may be a dilute aqueous solution of hydrochloric acid or acetic acid to prevent, for example, metallic deposition on the surface of the electronic component. Surfactants, anti-corrosion agents, and/or ozone are other additives used in rinsing fluids. The concentration of such additives in the rinsing fluid is minute. For example, the concentration is preferably not greater than about 1000 ppm by weight and more preferably not greater than 100 ppm by weight, based on the total weight of the rinsing fluid. In the case of ozone, the concentration in the rinsing fluid is preferably about 5 ppm.

One skilled in the art will recognize that the selection of chemical treatment fluids and the sequence of chemical treatment fluids and rinsing fluids will depend upon the desired wet processing results. For example, the electronic components could be contacted with a rinsing fluid before or after one or more chemical treatment steps. Alternatively, it may be desired in some wet processing methods to have one chemical treatment step directly follow another chemical treatment step, without contacting the electronic components with a rinsing fluid between two chemical treatment steps (i.e., no intervening rinse). Such sequential wet processing, with no intervening rinse, is described in, for example, U.S. Pat. No. 6,132,522, which is incorporated herein by reference in its entirety.

For example, in one embodiment of the present invention, the electronic components are contacted with a rinsing fluid, such as deionized water, to wet the surfaces of the electronic components prior to contacting the electronic components with the tantalum processing solution. Preferably, in such a wet processing step, the rinsing fluid is at a temperature of from about 20° C. to about 60° C. and more preferably from about 20° C. to about 40° C. It may also be desirable-to add a surfactant to such rinsing fluid, preferably at the levels previously described for the tantalum oxidizing solution.

In another embodiment of the present invention, the electronic components are contacted with a rinsing fluid after contacting the electronic components with the tantalum processing solution. The rinsing fluid is preferably deionized water at a temperature of from about 20° C. to about 60° C. The electronic components are preferably contacted with the rinsing fluid for a contact time sufficient to remove residual chemicals, reaction by-products, and/or particles or other contaminants loosened from treatment with the tantalum processing solution. The rinsing fluid in such a step preferably contains low levels of dissolved or suspended oxygen to minimize the risk of reoxidation of the tantalum.

As mentioned previously, it may be desirable to add a surfactant to process liquids used in the present invention. The presence of one or more surfactants in a process liquid is especially preferred (including the tantalum oxidizing solution, hydrofluoric acid solution or rinsing liquid) where the electronic components will be exposed to a gas-liquid interface. For example, an electronic component may be exposed to a gas-liquid interface during immersion or withdrawal of the electronic component in a process liquid. The electronic components may also be exposed to a gas-liquid interface during the filling of a vessel with a process liquid. It has been found that surfactants aid in reducing particle deposition or adhesion in several ways. For example, a surfactant will concentrate in the liquid at the gas-liquid interface (i.e., liquid surface), thereby displacing particles at the liquid surface. Minimizing the amount of particles at the liquid surface reduces the likelihood of a particle at the liquid surface coming into contact with the electronic component. Also, the surfactant provides an electrochemical barrier to prevent further particulate adhesion.

There are various ways in which the electronic components can be wet processed in accordance with the method of the present invention. For example, wet processing can be carried out using sonic energy (such as in the megasonic energy range) during the contacting of the electronic components with a process liquid to enhance cleaning. Such methods may include wet processing techniques disclosed in, for example, U.S. Pat. Nos. 5,383,484; 6,132,522; 6,245,158; U.S. patent application Ser. No. 09/209,101, filed Dec. 10, 1998; and 09/253,157, filed Feb. 19, 1999; and U.S. Provisional Patent Application Ser. No. 60/111,350 filed Dec. 8,1998, the disclosures of which are all incorporated herein by reference in their entireties.

The methods of the invention may be carried out in generally any wet processing equipment including, for example, spray systems, multiple bath systems (e.g., wet bench), and single vessel systems (open or closable to the environment). See, e.g., Chapter 1: Overview and Evolution of Semiconductor Wafer Contamination and Cleaning Technology by Werner Kern and Chapter 3: Aqueous Cleaning Processes by Don C. Burkman, Donald Deal, Donald C. Grant, and Charlie A. Peterson in Handbook of Semiconductor Wafer Cleaning Technology (edited by Werner Kern, Published by Noyes Publication Parkridge, N.J. 1993), and Wet Etch Cleaning by Hiroyuki Horiki and Takao Nakazawa in Ultraclean Technology Handbook, Volume 1, (edited by Tadahiro Ohmi published by Marcel Dekker), the disclosures of which are herein incorporated by reference in their entirety. Additionally, when a wet bench is used, the oxidizing solution can be metered in at a controlled rate to maintain the concentration of the oxidizing agent at a relatively constant level.

In a preferred embodiment of the invention, the electronic components are housed in a single, enclosable vessel system. The enclosable wet processing system is also preferably capable of receiving different process fluids in various sequences. A preferred method of delivering process fluids to the vessel is by direct displacement of one fluid with another. Preferably the single vessel system used is of the type disclosed in U.S. Pat. Nos. 4,778,532; 4,917,123; 4,911,761; 4,795,497; 4,899,767; 4,984,597; 4,633,893; 4,917,123; 4,738,272; 4,577,650; 5,571,337; and 5,569,330, the disclosures of which are herein incorporated by reference in their entirety. Preferred commercially available single vessel systems are Full-Flow™ and Poseidon® vessels such as those manufactured by Mattson, and FL820L manufactured by Dainippon Screen. Such systems are preferred because the oxygen levels and chemical concentrations can be more readily controlled, thereby minimizing the risk of reoxidation once the surfaces of the electronic components are cleaned.

In a preferred method of the present invention, one or more electronic components are placed in a single, enclosable process vessel and closed to the environment. The use of a single pass chemistry in a closed environment is especially preferred when the tantalum processing solution degrades at the concentrations and temperatures used. For example, a single pass, closed environment is beneficial when the tantalum processing fluid contains peroxide. Prior to contacting the electronic components with the tantalum processing solution, the electronic components may optionally be contacted with a rinsing fluid or any other desired process fluid for pretreatment of the electronic component. Such contacting can be accomplished by directing the fluid into the process vessel to fill the process vessel with the fluid so that gases from the atmosphere or residual fluid from a previous step are not significantly trapped within the vessel. The fluid can be continuously directed through the vessel once the vessel is full of fluid, or the flow of fluid can be stopped to soak the electronic components for a desired time. Following such pretreatment steps, the fluid currently in the vessel is removed from the vessel, and the tantalum processing fluid is directed into the vessel to contact the electronic components. The tantalum processing fluid can be continuously directed through the vessel or the flow of the tantalum processing fluid can be stopped to soak the components for a desired time. Following contact with the tantalum processing fluid, the electronic components may be optionally rinsed and/or treated in any other desired manner.

The replacement of one process fluid with another process fluid in the enclosable single vessel can be accomplished in several ways. For example, the process fluid in the process vessel can be completely removed (i.e., drained) with the next process fluid being directed into the vessel during or after draining. In another embodiment, the process fluid present in the vessel is directly displaced by the next desired process fluid as described, for example, in U.S. Pat. No. 4,778,532, which is incorporated herein by reference in its entirety.

Following wet processing with chemical treatment or rinsing fluids, the electronic components are preferably dried. By “dry” or “drying” it is meant that the electronic components are made substantially free of liquid droplets. By removing liquid droplets during drying, impurities present in the liquid droplets preferably do not remain on the surfaces of the semiconductor substrates when the liquid droplets evaporate. Such impurities leave undesirable marks (e.g., watermarks) or other residues on the surfaces of the semiconductor substrates. However, it is also contemplated that drying may simply involve removing a treating, or rinsing fluid, for example with the aid of a drying fluid stream, or by other means known to those skilled in the art. Any method or system of drying may be used. Suitable methods of drying include for example evaporation, centrifugal force in a spin-rinser-dryer, steam or chemical drying, or combinations thereof.

A preferred method of drying uses a drying fluid stream to directly displace the last processing solution that the electronic components are contacted with prior to drying (hereinafter referred to as “direct displace drying”). Suitable methods and systems for direct displace drying are disclosed in, for example, U.S. Pat. Nos. 4,778,532; 4,795,497; 4,911,761; 4,984,597; 5,571,337; and 5,569,330. Other direct displace dryers that can be used include Marangoni type dryers supplied by manufacturers such as Steag, Dainippon, YieldUp, and TEL. Most preferably, the system and method of U.S. Pat. No. 4,7911,761, which is incorporated herein by reference in its entirety, is used for drying the electronic components. Preferably, the drying fluid stream is formed from a partially or completely vaporized drying solution. The drying fluid stream may be, for example, superheated, a mixture of vapor and liquid, saturated vapor or a mixture of vapor and a noncondensible gas. The drying solution chosen to form the drying fluid stream is preferably miscible with the last process fluid in the vessel and non-reactive with the surfaces of the electronic components. The drying solution also preferably has a relatively low boiling point to facilitate drying. Since water is the most convenient and commonly used solvent for chemical treatment or rinsing fluids, a drying solution which forms a minimum-boiling azeotrope with water is especially preferred. For example, the drying solution is preferably selected from organic compounds having a boiling point of less than about 140° C. at atmospheric pressure. Examples of drying solutions which may be employed are steam; alcohols such as methanol, ethanol, 1-propanol, isopropanol, n-butanol, secbutanol, tertbutanol, or tert-amyl alcohol; acetone; acetonitrile; hexafluoroacetone; nitromethane; acetic acid; propionic acid; ethylene glycol mono-methyl ether; difluoroethane; ethyl acetate; isopropyl acetate; 1,1,2-trichloro-1,2,2-trifluoroethane; 1,2-dichloroethane; trichloroethane; perfluoro-2-butyltetrahydrofuran; perfluoro-1,4-dimethylcyclohexane; or combinations thereof. Preferably, the drying solution is a C₁ to C₆ alcohol, such as for example methanol, ethanol, 1-propanol, isopropanol, n-butanol, secbutanol, tertbutanol, tert-amyl alcohol, pentanol, hexanol or combinations thereof.

Preferably, to reduce the risk of reoxidation and contamination of the electronic components, the wet processing and drying is performed in a single vessel without removing the electronic components from the vessel. Suitable wet processing systems for carrying out both wet processing and drying in a single vessel include for example Full-Flow™ wet processing systems and Poseidon® manufactured by Mattson, and FL820L manufactured by Dainippon Screen.

Following drying, the electronic components may be removed from the drying vessel and further processed in any desired manner.

The electronic components obtained using the methods of the present invention preferably are substantially free of particle contamination. By “substantially free” it is meant that the semiconductor substrates contain preferably less than about 0.05 particles per cm², and more preferably less than about 0.016 particles per cm². The size of particles remaining on the semiconductor substrate is preferably equal to or less than about 0.3 μm and more preferably less than about 0.12 μm in diameter as measured by KLA Tencor SP1 particle scanning equipment. Preferably all particles greater than 0.3 μm are removed using the methods of the present invention.

### EXAMPLES

Electronic components were prepared having either a tantalum layer or a tantalum nitride layer. The electronic components were then etched using a solution containing buffered hydrofluoric acid (BHF) and hydrogen peroxide (H₂O₂). The etching was conducted by simultaneous injection of HF:NH₄OH:H₂O₂ (i.e., BHF and H₂O₂) into a flowing deionized water stream in a Full-Flow™ system (Mattson). The relative concentrations of the components of the etching solution were 10:1:1:2 (Deionized water:HF:NH₄OH:H₂O₂). The hydrogen peroxide quickly oxidized the Ta or TaN, while fluoride ions from the BHF acted to solubilize the resulting oxide. Etch rates of about 20 Å per minute were achieved at approximately 55° C. The combination of the oxidizing agent and the fluoride ion source was critical in achieving a single process wet etch of the Ta or TaN layer.

Although the present invention has been described above with respect to particular preferred embodiments, it will be apparent to those skilled in the art that numerous modifications and variations can be made to those designs. The descriptions provided are for illustrative purposes and are not intended to limit the invention.

What is claimed is:

1. A method of wet processing electronic components having surfaces containing tantalum comprising contacting the surfaces of the electronic components with a processing fluid comprising a tantalum oxidizing solution and a fluorine ion producing agent maintained at an aqueous pH of 5 or lower.

2. The method of claim 1 wherein the contacting of the surfaces of the electronic components with the tantalum processing fluid removes contaminants from the surfaces of the electronic components.

3. The method of claim 1 wherein the contacting of the surfaces of the electronic components with the tantalum processing fluid etches the surfaces of the electronic components.

4. The method of claim 1 wherein the tantalum oxidizing solution comprises an oxidizing agent selected from the group consisting of hydrogen peroxide, ozone, chromic acid, nitric acid, iron cyanide and combinations thereof.

5. The method of claim 4 wherein the oxidizing agent is selected from the group consisting of hydrogen peroxide, ozone, and combinations thereof.

6. The method of claim 5 wherein the tantalum oxidizing solution comprises hydrogen peroxide and water, and the hydrogen peroxide is present in the tantalum oxidizing solution in an amount of at least about 0.1 volume percent based on the total volume of the tantalum oxidizing solution.

7. The method of claim 6 wherein the tantalum oxidizing solution comprises water, hydrogen peroxide, and ammonium hydroxide.

8. The method of claim 7 wherein the water, hydrogen peroxide and ammonium hydroxide are present in the tantalum oxidizing solution in a volume ratio of H₂O:H₂O₂:NH₄OH of about 5:1:1 to about 200:1:1.

9. The method of claim 1 wherein the fluorine ion producing agent comprises hydrofluoric acid and deionized water in a volume ratio of H₂O:HF of from about 5:1 to about 1000:1.

10. The method of claim 9 wherein the fluorine ion producing agent is maintained at a pH of about 3 or less.

11. The method of claim 10 wherein the fluorine ion producing agent further comprises hydrochloric acid.

12. The method of claim 11 wherein the fluorine ion producing agent comprises the deionized water, hydrofluoric acid, and hydrochloric acid in a volume ratio of H₂O:HF:HCl of from about 50:1:1 to about 1000:1:1.

13. The method of claim 1 wherein the electronic components are rinsed with a rinsing liquid comprising deionized water after contacting the electronic components with the tantalum processing solution.

14. The method of claim 1 wherein the tantalum processing solution comprises a surfactant, anti-corrosion agent or combinations thereof.

15. A method of wet processing electronic components having surfaces containing tantalum comprising:
(a) placing one or more electronic components having surfaces containing tantalum in a single vessel;
(b) filling the vessel with a tantalum processing fluid comprising an oxidizing agent and a fluorine ion producing agent having a pH of 5 or lower; and
(c) contacting the electronic components with the tantalum processing fluid for a contact time sufficient to remove tantalum or tantalum nitride from the surfaces of the electronic components.

16. The method of claim 15 wherein the tantalum processing solution is removed from the vessel by direct displacement using another process fluid.

17. The method of claim 15 wherein the contacting of the surfaces of the electronic components with the tantalum processing fluid removes contaminants from the surfaces of the electronic components.

18. The method of claim 15 wherein the contacting of the surfaces of the electronic components with the tantalum processing fluid etches the surfaces of the electronic components.

19. The method of claim 15 wherein the tantalum oxidizing solution comprises an oxidizing agent selected from the group consisting of hydrogen peroxide, ozone, chromic acid, nitric acid, iron cyanide and combinations thereof.

20. The method of claim 19 wherein the oxidizing agent is selected from the group consisting of hydrogen peroxide, ozone, and combinations thereof.

21. The method of claim 20 wherein the tantalum oxidizing solution comprises hydrogen peroxide and water, and the hydrogen peroxide is present in the tantalum oxidizing solution in an amount of at least about 0.1 volume percent based on the total volume of the tantalum oxidizing solution.

22. The method of claim 21 wherein the tantalum oxidizing solution comprises water, hydrogen peroxide, and ammonium hydroxide.

23. The method of claim 22 wherein the water, hydrogen peroxide and ammonium hydroxide are present in the tantalum oxidizing solution in a volume ratio of H₂O:H₂O₂:NH₄OH of about 5:1:1 to about 200:1:1.

24. The method of claim 15 wherein the fluorine ion producing agent comprises hydrofluoric acid and deionized water in a volume ratio of H₂O:HF of from about 5:1 to about 1000:1.

25. The method of claim 24 wherein the fluorine ion producing agent is maintained at a pH of about 3 or less.

26. The method of claim 25 wherein the fluorine ion producing agent further comprises hydrochloric acid.

27. The method of claim 26 wherein the fluorine ion producing agent comprises the deionized water, hydrofluoric acid, and hydrochloric acid in a volume ratio of H₂O:HF:HCI of from about 50:1:1 to about 1000:1:1.

28. The method of claim 15 wherein the electronic components are rinsed with a rinsing liquid comprising deionized water after contacting the electronic components with the tantalum processing solution.
